(19) United States
(12) Patent Application Publication
(10) Pub. No.: US 2006/0203774 A1
(43) Pub. Date: Sep. 14, 2006

(54) System, method and apparatus for selecting a remote tunnel endpoint for accessing packet data services

(75) Inventor: Inmaculada Carrion-Rodrigo, San Diego, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/193,113

(22) Filed: Jul. 29, 2005

Related U.S. Application Data
(60) Provisional application No. 60/660,474, filed on Mar. 10, 2005.

(51) Int. Cl. H04Q 7/00

(52) U.S. Cl. 370/331

(57) ABSTRACT

A system, method, apparatus, mobile station, server and computer program product for enabling a mobile station and/or network operator to select the remote tunnel endpoint, e.g., Packet Data Interworking Function (PDIF), used for the establishment of a secure tunnel to be used when accessing services, such as Packet Data Services, are provided.

### CROSS REFERENCE TO RELATED APPLICATION(S)

The present application claims priority from U.S. Provisional Application No. 60/660,474, filed Mar. 10, 2005 entitled System and Method for Selecting a Packet Data Interworking Function, the contents of which are incorporated herein in their entirety.

### FIELD OF THE INVENTION

This invention relates to service provisioning, and more particularly to mechanisms by which a mobile station and/or network operator can select one of a plurality of remote tunnel endpoints (RTEs) based upon various parameters, such as the service that the mobile station is to use, the network operator to be used and/or the location of the service provider for the mobile station's subscriber.

### BACKGROUND OF THE INVENTION

CDMA2000, also known as IMT-CDMA, is a code-division multiple access (CDMA) version of the IMT-2000 (International Mobile Telecommunications-2000) standard developed by the International Telecommunication Union (ITU). The CDMA2000 standard is third-generation (3G) mobile telecommunications technology. CDMA2000 can support mobile data communications at speeds ranging from 144 Kbps to 2 Mbps, and in 2000, was the first 3G technology to be commercially deployed as part of the ITU's IMT-2000 framework.

A new feature that will provide secure access to CDMA2000 Packet Data Services by a mobile station, such as a mobile phone, personal digital assistant (PDA), or mobile personal computer (PC), is currently being developed in CDMA2000 WLAN IW (Wireless Local Area Network Interworking) by 3GPP2 (3^{rd} Generation Partnership Project 2), a cooperation of standards organizations throughout the world for the development of 3G data capabilities. Packet Data Services are high layer services (e.g., Multimedia Domain) offered by the CDMA2000 operator.

In general, this feature is provided by setting up a tunnel between the mobile station (MS) and a remote tunnel endpoint (RTE) referred to as a PDIF (Packet Data Interworking Function), a new network element which provides access to the Packet Data Services by providing IP connectivity to the CDMA2000 operator's network and/or other external networks (e.g., Corporate Service Access). The PDIF implements end-to-end secure tunnel management procedures between itself and the MS, including the establishment and release of the tunnel, allocation of an IP address to the MS from the CDMA2000 operator's network, and encapsulation and de-capsulation of traffic to and from the MS. The PDIF also enforces the CDMA2000 operator's policies such as packet filtering and routing. Through the interface to a Home-Authentication, Authorization and Accounting (H-AAA) server, the PDIF supports user authentication and transfer of authorization policy information. The PDIF also collects and transmits pre-tunnel accounting information.

In some instances, two or more network operators will share access networks. In other words, one or more RTEs, such as, for example, one or more PDIFs, associated with each network operator will be accessible via the same access network (e.g., the same WLAN). In other instances, one network operator will have several RTEs connected and, therefore, available for the home subscriber, via one or more access networks. In yet another instance, different RTEs may provide access to different services. The amounts charged for these services may further be different depending upon the RTE that the MS is setting up the tunnel with.

In these and other situations, there is a desire to enable the MS and/or the network operator to select a RTE (e.g., PDIF), such as based on the desired service and/or the desired network operator, and to subsequently establish a secure tunnel with the selected RTE for accessing at least one of a plurality of packet data services (PDSs), for example, CDMA2000 Packet Data Services. This would be beneficial, for example, where the desired service is a call to an emergency call service, since the network could rely on this information to save time on tunnel establishment (e.g., by not performing certain security checks), to trigger location services for the MS and to allocate an RTE that has a connection to the appropriate emergency service center. Currently, however, there is no mechanism by which the MS can influence which RTE the network will allocate for the tunnel establishment. The network operator is also unable to allocate an RTE based on the MS's (i.e., the user's) preferences (e.g., services, target network, etc.). Further, there is no mechanism by which the MS can indicate to the network which service it is wishing to use and the desired location of that service (e.g., visited/local or home network).

### BRIEF SUMMARY OF THE INVENTION

Generally described, embodiments of the present invention provide an improvement over the known prior art by providing a means by which a MS and/or network operator can select which remote tunnel endpoint, such as, for example a PDIF, to use for tunnel establishment when accessing services, such as, but not limited to, packet data services (e.g., CDMA2000 Packet Data Services). In particular, embodiments of the present invention provide an IP Service Identifier that can be used in conjunction with, for example, a DNS (Domain Name System) procedure in order to retrieve a list of RTE addresses from which the MS and/or network operator can choose.

According to one exemplary aspect of the present invention a method of establishing a tunnel to a remote tunnel endpoint is provided. In one exemplary embodiment, the method includes: (1) building an identifier identifying one or more characteristics of one or more services being accessed by a mobile station; (2) transmitting a request for one or more addresses associated with one or more remote tunnel endpoints through which the mobile station can access the services, wherein the request includes the identifier; (3) receiving, in response to the request, one or more addresses associated with one or more remote tunnel endpoints that are capable of supporting the tunnel for accessing the services described in the identifier; (4) selecting one or more of the addresses received; and (4) initiating tunnel establishment toward one or more remote tunnel endpoints associated with the one or more addresses selected.

According to another exemplary aspect of the present invention a method of selecting a Packet Data Interworking Function (PDIF) for the purpose of establishing a tunnel to enable a mobile station to access at least one of a plurality of packet data services is provided. In one exemplary embodiment, the method includes: (1) building an IP Service Identifier (ISI) identifying the packet data service being accessed and a network operator associated with the packet data service; (2) transmitting a Domain Name System (DNS) request, wherein the DNS request includes the ISI; (3) receiving, in response to the DNS request, one or more IP addresses associated with one or more PDIFs that are capable of supporting the tunnel for accessing the packet data service described in the ISI; (4) selecting one or more of the IP addresses received; and (4) initiating tunnel establishment toward one or more PDIFs associated with the one or more addresses selected.

According to yet another exemplary aspect of the present invention an apparatus capable of establishing a tunnel to a remote tunnel endpoint is provided. In one exemplary embodiment, the apparatus includes a processor and a memory component in communication with the processor that stores an application executable by the processor. The application may be capable, upon execution, of: (1) building an identifier identifying one or more characteristics of a service being accessed by the apparatus; (2) transmitting a request to a network server that includes the identifier; (3) receiving, in response to the request, one or more addresses associated with one or more remote tunnel endpoints; (4) selecting one or more of the addresses received; and (5) initiating tunnel establishment toward one or more remote tunnel endpoints associated with the one or more addresses selected.

According to yet another aspect of the present invention a mobile station capable of requesting and selecting a remote tunnel endpoint for the purpose of establishing a tunnel to be used when accessing at least one of a plurality of services is provided. In one exemplary embodiment the mobile station includes means, such as a processor and a memory module in communication with the processor, for (1) building an identifier identifying one or more characteristics of the service being accessed by the mobile station; (2) transmitting a request for one or more addresses associated with one or more remote tunnel endpoints through which the mobile station can access the service, wherein the request includes the identifier; (3) receiving, in response to the request, one or more addresses associated with one or more remote tunnel endpoints that are capable of supporting the tunnel for accessing the service described in the identifier; (4) selecting one or more of the addresses received; and (5) initiating tunnel establishment toward one or more remote tunnel endpoints associated with one or more addresses selected.

According to another aspect of the present invention a server capable of providing one or more addresses associated with one or more remote tunnel endpoints that can be used by a mobile station to establish a tunnel for accessing at least one of a plurality of services is provided. In one exemplary embodiment, the server includes means, such as a processing device, for: (1) receiving a request from the mobile station for one or more addresses associated with one or more remote tunnel endpoints through which the mobile station can access one of the plurality of services, wherein the request includes one or more characteristics of the service the mobile station desires to access; and (2) providing to the mobile station one or more addresses associated with one or more remote tunnel endpoints that are capable of supporting access to the service, based at least in part on the characteristics of the service included in the request. In one exemplary embodiment, the server further includes means for generating and/or retrieving the one or more addresses associated with one or more remote tunnel endpoints capable of supporting access to the service.

According to yet another exemplary aspect of the present invention a system for establishing a tunnel to a remote tunnel endpoint is provided. In one exemplary embodiment, the system includes a mobile station and a server, such as a Domain Name System (DNS) server, in communication with the mobile station. In one embodiment the mobile station is capable of generating a request for one or more addresses associated with one or more remote tunnel endpoints through which the mobile station can access one of a plurality of services, wherein the request includes an identifier identifying one or more characteristics of service the mobile station desires to access. The server receives the request, and provides to the mobile station one or more addresses associated with one or more remote tunnel endpoints that can be used by the mobile station to access the service, based at least in part on the characteristics of the service included in the identifier. In one exemplary embodiment, the mobile station selects one or more of the addresses provided by the server and initiates tunnel establishment toward one or more remote tunnel endpoints associated with the one or more addresses selected.

According to another exemplary aspect of the present invention a computer program product for selecting a remote tunnel endpoint for the purpose of establishing a tunnel to enable a mobile station to access at least one of a plurality of services is provided. In one exemplary embodiment, the computer program product includes at least one computer-readable storage medium having computer-readable program code portions stored therein. In one exemplary embodiment, the computer-readable program code portions include: (1) a first executable portion for building an identifier identifying one or more characteristics of the service being accessed by the mobile station; (2) a second executable portion for transmitting a request for one or more addresses associated with one or more remote tunnel endpoints through which the mobile station can access the service, wherein the request includes the identifier; (3) a third executable portion for receiving, in response to the request, one or more addresses associated with one or more remote tunnel endpoints that are capable of supporting the tunnel for accessing the service described in the identifier; (4) a fourth executable portion for selecting one or more of the addresses received; and (5) a fifth executable portion for initiating tunnel establishment toward one or more remote tunnel endpoints associated with the one or more addresses selected.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a typical, non-roaming WLAN IW architecture for accessing CDMA2000 Packet Data Services wherein the PDIF is part of the Home Network;

FIG. 2 illustrates a typical, roaming WLAN IW architecture for accessing CDMA2000 Packet Data Services wherein the PDIF is part of the local or visited network;

FIG. 3 is a schematic block diagram of a mobile station capable of operating in accordance with exemplary embodiments of the present invention; and

FIG. 4 is a signal flow diagram of the PDIF selection process according to exemplary embodiments of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overview:

In one embodiment, an IP Service Identifier (ISI), which may be in the format of a fully qualified domain name (FQDN), is provided that can be used by a mobile station (MS), typically in conjunction with a DNS procedure, in order to enable the MS and/or network operator to select which of several remote tunnel endpoints (RTEs) (e.g., Packet Data Interworking Functions (PDIFs)), the MS will establish a tunnel to in order to access services, such as Packet Data Services. In one embodiment, this ISI includes some combination of (1) an indication of the service the MS is intending to use once the tunnel is established, (2) an indication of the network operator being used, whether home or visited, and (3) an indication of the location of the mobile station subscriber's service provider. These indications are then used by a server receiving the ISI, such as a DNS server as part of a DNS request, to retrieve the addresses of one or more available RTEs. The MS is then able to select from among these available RTEs for tunnel establishment.

In one embodiment, the ISI is further conveyed to a core network, (i.e., the entity in charge of service authorization, for example, in the case of 3GPP2 WLAN IW the AAA server) when the MS requests tunnel establishment. By doing so, the home network operator is ensured to have the necessary information to authorize the particular operator service requested by the user.

For exemplary purposes only, the following description of exemplary embodiments of the present invention is given in terms of CDMA2000 Packet Data Services, wherein a Packet Data Interworking Function (PDIF) is used as the remote tunnel endpoint (RTE). As will be understood by those of ordinary skill in the art, however, exemplary embodiments of the present invention are not limited to the CDMA2000 standard. In contrast, exemplary embodiments can be used in relation to, for example, Global System for Mobile Communications (GSM), Time Division Multiple Access (TDMA), or Wireless CDMA (WCDMA) standards, to name a few, and further in relation to any available packet data services (PDSs).

Overall System and Mobile Station

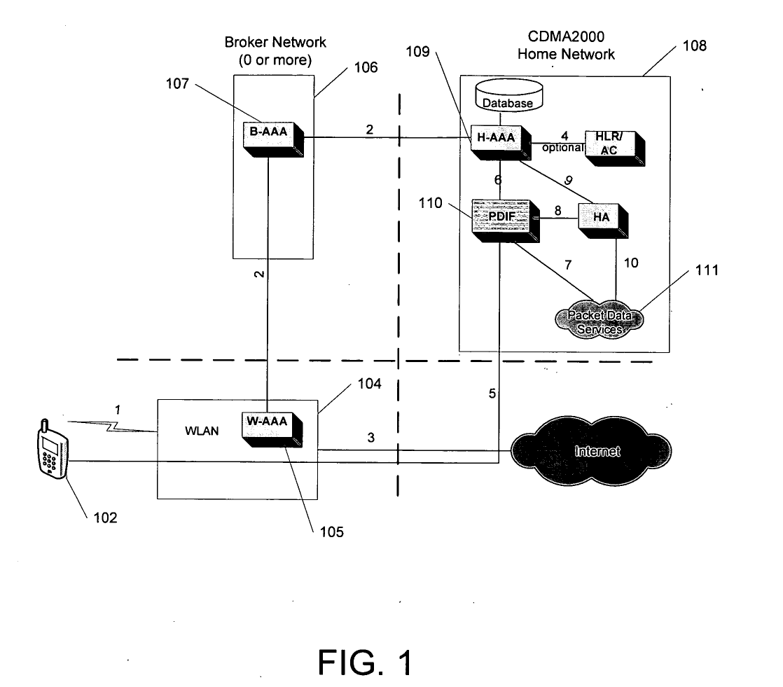

FIG. 1 illustrates a typical, non-roaming WLAN IW architecture for accessing CDMA2000 Packet Data Services. While the embodiments included herein are discussed in the WLAN IW environment, it will be understood by those of skill in the art that the present invention could be used in other environments requiring bearer path establishment, such as CDMA2000 and other networks. Certain aspects of this invention could also be used in WLAN IW 3GPP networks, for example for emergency calls or for local HA (home agent) discovery.

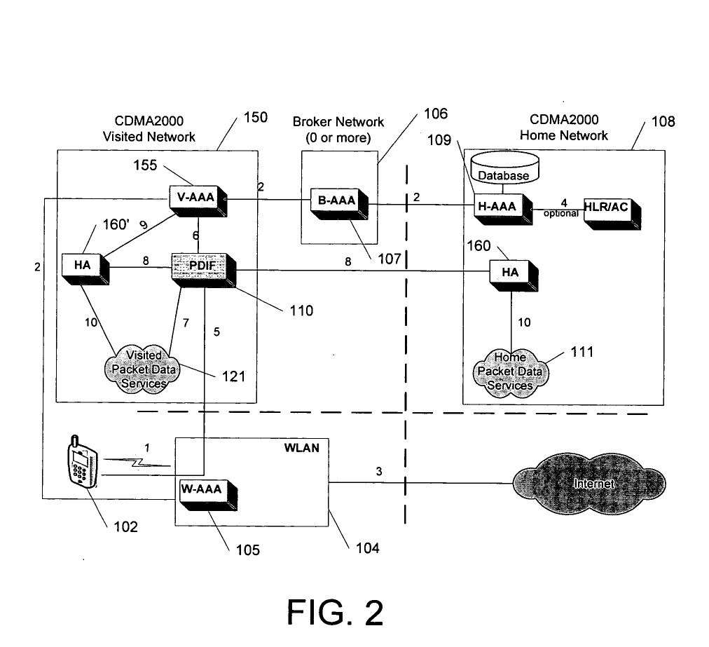

As shown, in FIG. 1, in one embodiment, the PDIF 110 is located in the Home Network 108. Alternatively, the PDIF 110 could be located in the visited network, as shown in FIG. 2, discussed below. In either embodiment, the process of accessing the CDMA2000 Packet Data Services begins when a mobile station 102 initiates communication with the local area network, which in this instance is a WLAN 104, in order to request access to a particular CDMA2000 Packet Data Service 111. In this regard, it is noted that the links or interfaces between the elements of FIGS. 1 and 2 are sequentially numbered so as to illustrate the order in which the elements communicate with one another.

Initially, the WLAN 104 and, in particular, a W-AAA (Wireless-Authentication, Authorization and Accounting) server 105 located on the WLAN 104 contacts the H-AAA (Home-AAA) server 109 located on the Home Network 108 to determine whether or not the MS subscriber is authorized to access the Packet Data Service specified. This contact may either be direct or the W-AAA may first contact a B-AAA (Broker-AAA) server 107 located on a Broker Network 106 to locate the MS subscriber's Home Network 108. Once the MS subscriber's Home Network 108 has been located, the W-AAA 107 can then contact the H-AAA server.

Once the MS 102 has been authorized to access the CDMA2000 Packet Data Service 111, the MS 102 will initiate IPSec (IP Security) tunnel establishment with the PDIF 110. Once the tunnel is established between the MS 102 and a PDIF 110 selected as described below in accordance with embodiments of the present invention, the PDIF 110 can then provide the MS 102 with access to the Packet Data Service 111 by providing IP connectivity to the CDMA2000 operator's network, implementing end-to-end secure tunnel management procedures between itself and the MS, enforcing the CDMA2000 operator's policies, supporting user authentication and transferring authorization policy information, and collecting and transmitting pre-tunnel accounting information.

FIG. 2 illustrates the WLAN IW architecture in which the PDIF 110 is part of the local or visited network 150, rather than the Home Network 108, as in the embodiment of FIG. 1. As shown, the PDIF 110 of the visited network 150 facilitates access to packet data services 121 in the visited network as well as in the home network via a home agent 160. In this embodiment, the interface (interface 2) between the MS 102 and W-AAA 105, V-AAA (Visited-AAA) 155, and H-AAA 109 supports the transfer of authentication data exchanged between the PDIF 110 and the H-AAA 109 used for tunnel management procedures. Interface 2 also supports the transfer of per-tunnel charging information. In one embodiment, this interface is based on IETF RADIUS and/or Diameter specifications.

Interface 5 is the tunnel interface between the MS 102 and the PDIF 110, which supports, for example, the MS-initiated tunnel establishment, user data packet transmission within the MS-initiated tunnel, and the tear down of the MS-initiated tunnel. Interface 6, between the PDIF and the H-AAA, supports retrieval of tunneling attributes and the MS's IP configuration parameters from the AAA, user authentication and authorization, tunnel establishment, tunnel data authentication and encryption, mapping of a user identifier and a tunnel identifier, etc. In one embodiment, this interface is based on IETF Diameter specifications.

The interface between the PDIF 110 and the Packet Data Services 121 (interface 7) provides access to the CDMA2000 Packet Data Services (e.g., Multimedia Domain) offered by the visited network and includes bearer and policy control signaling. Interface 8 between the PDIF 110 and the HA 160′ is outside of the scope if the PDIF and the HA are co-located. Interface 9 between the HA of the visited network and the V-AAA 155 supports retrieval of MS's IP configuration and user authentication and authorization parameters from the V-AAA. This interface is used when the MS initiates a MIP tunnel establishment with a previous IPSec tunnel established in the PDIF. Finally, Interface 10 between the HA and the Packet Data Services provides access to the CDMA2000 Packet Data Services offered by the home network.

In a conventional implementation of either embodiment (i.e., whether the PDIF is an element of the Home or the visited network), neither the MS nor the network operator is able to specify which PDIF is to be used for tunnel establishment and for accessing Packet Data Services in instances in which multiple PDIFs are available. In conventional networks, it is also not possible for the MS to indicate to the network that has been accessed either which Packet Data Service the MS wishes to use or the desired location of that service.

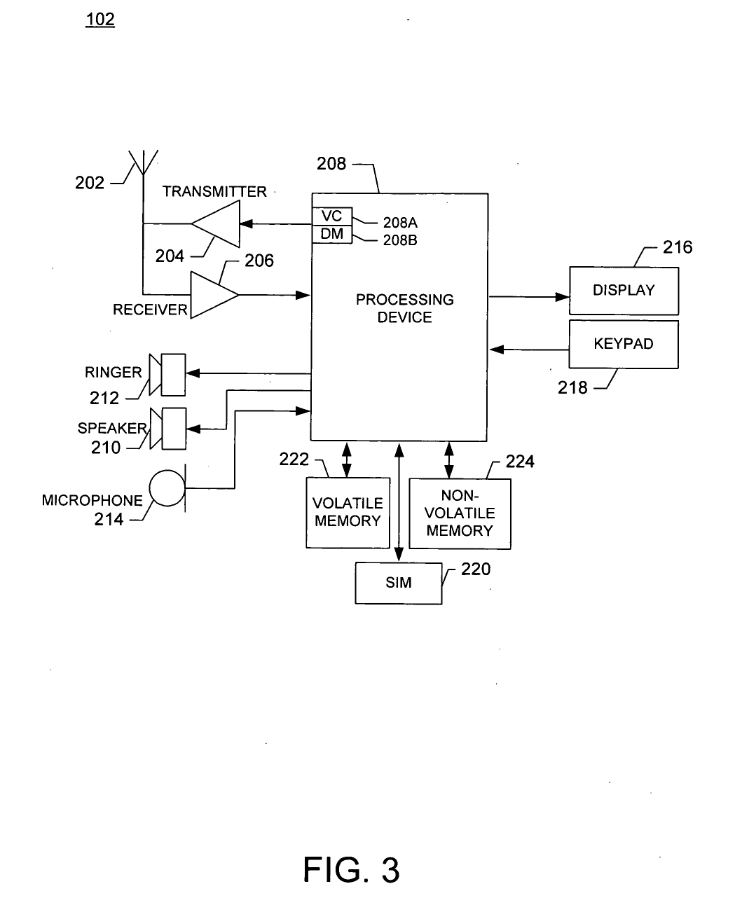

FIG. 3 is a schematic block diagram of a mobile station 102 capable of operating in accordance with exemplary embodiments of the present invention. The mobile station 102, or other digital device, includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 3, the entity can include an antenna 202, a transmitter 204, a receiver 206, and means, such as a processing device 208, e.g., a processor, controller or the like, that provides signals to and receives signals from the transmitter 204 and receiver 206, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5 G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 208, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 208 thus also includes the functionality to convolutionally encode and interleave message and data prior to modulation and transmission. The processing device can additionally include an internal voice coder (VC) 208A, and may include an internal data modem (DM) 208B. Further, the processing device 208 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 210, a ringer 212, a microphone 214, a display 216, all of which are coupled to the controller 208. The user input interface, which allows the mobile device to receive data, can comprise any of a number of devices allowing the mobile device to receive data, such as a keypad 218, a touch display (not shown), a microphone 214, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 220, a removable user identity module (R-UIM) (not shown), or the like, which typically stores information elements related to a mobile subscriber. In addition to the SIM, the mobile device can include other memory. In this regard, the mobile station can include volatile memory 222, as well as other non-volatile memory 224, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for enabling the mobile station to generate an identifier, which could be in the form of a fully qualified domain name (FQDN), which provides information that can be used to generate a list of one of more addresses associated with one or more remote terminal endpoints (RTEs) from which the mobile station, and/or some other network entity, can select for the purpose of accessing at least one of a plurality of services, such as packet data services.

The system, method, device and computer program product of exemplary embodiments of the present invention are primarily described in conjunction with mobile communications applications. It should be understood, however, that the system, method, device and computer program product of embodiments of the present invention can be utilized in conjunction with a variety of other applications, both in the mobile communications industries and outside of the mobile communications industries. For example, the system, method, device and computer program product of exemplary embodiments of the present invention can be utilized in conjunction with wireline and/or wireless network (e.g., Internet) applications.

Also, it should be understood that while the terminal was illustrated and described as comprising a mobile telephone, mobile telephones are merely illustrative of one type of terminal that would benefit from the present invention and, therefore, should not be taken to limit the scope of the present invention. While several embodiments of the terminal are illustrated and described for purposes of example, other types of terminals, such as portable digital assistants (PDAs), pagers, laptop computers, tablets, and other types of electronic systems including both mobile, wireless devices and fixed, wireline devices, can readily employ embodiments of the present invention.

Enabling Selection of Remote Tunnel Endpoint (RTE)

Exemplary embodiments of the present invention provide a means of enabling the MS and/or network operator to specify which RTE (e.g.,PDIF) is to be used for tunnel establishment based on various parameters including, for example, some combination of (1) the particular service to be provided, (2) the network operator being used, and (3) the location of the service provider. In one embodiment, this is done by enabling the MS to transmit an IP Service Identifier containing some combination of (1), (2) and (3) to a DNS server, which will retrieve the addresses of one or more RTEs meeting those qualifications and transmit a list of those addresses to the MS for selection.

In general, a mobile station (MS), according to an embodiment of the present invention, supports the implementation of standard DNS mechanisms in order to retrieve IP address(es) of one or more remote tunnel endpoints (e.g., PDIFs) for tunnel establishment. To do this, in one exemplary embodiment, the MS must first build an identifier, which could be in the form of a fully qualified domain name (FQDN), for a DNS request to be transmitted to a DNS server. In one embodiment, this identifier, which is referred to in this embodiment as an IP Service Identifier (ISI), identifies the IP network the user wants to access (e.g., the operator service network) or the Internet, and in which operator network the RTE (e.g., PDIF) is located (e.g., home or visited). Upon receipt of the DNS request, in one exemplary embodiment, the DNS server will retrieve the IP address(es) of one or more PDIFs that match the qualifications provided by the DNS request and return a list of those addresses in a response to the MS. As known to those skilled in the art, a DNS server includes means, such as a processing device, such as a processor, controller or other computing device, for performing its various functions, generally under the software control. Upon receipt of the DNS response, the MS will, in one exemplary embodiment, select an IP address with the same IP version as its local IP address (i.e., the IP address allocated by the WLAN at successful association). This selection may be performed by the user (MS implementation option) or automatically by the MS. In the ladder case, the criteria for automatic selection are implementation dependent. There are several mechanisms the MS could use to acquire the IP address of the DNS server and to discover the PDIF. For example, for IPv4, DHCP (dynamic host configuration protocol) may be used, while for IPv6, DHCP, Anycast address and Router advertisements may be used.

A practical example of how embodiments of the present invention could be used is where a user wants to use his or her mobile station to make an emergency call, for example an IMS (Instant Message System) emergency call. In this example, the MS could indicate in the ISI that an emergency call is going to follow the tunnel setup. This would enable the DNS server to retrieve and give back to the MS an appropriate PDIF to provide emergency calls. MS could also indicate in the ISI the current location (e.g., Access Point name, or some other way of transmitting location), which could further be used by the DNS server in assigning the right PDIF. The core network (i.e., the H-AAA and/or PDIF) could use the emergency call indication within the ISI, together with the IMS setup signaling parameters (such as dialed number, target IP address, etc.) to find out whether the call is really an emergency call. If it is, then the charging and authorization/authentication may not be applied in order to speed up the call setup. Another example of how the present invention could be used is to use the ISI to enable the MS to indicate to the core network a desire to use local services through the selected tunnel endpoint. This indication could then be used by the core network to identify that a local HA has to be provided to the MS.

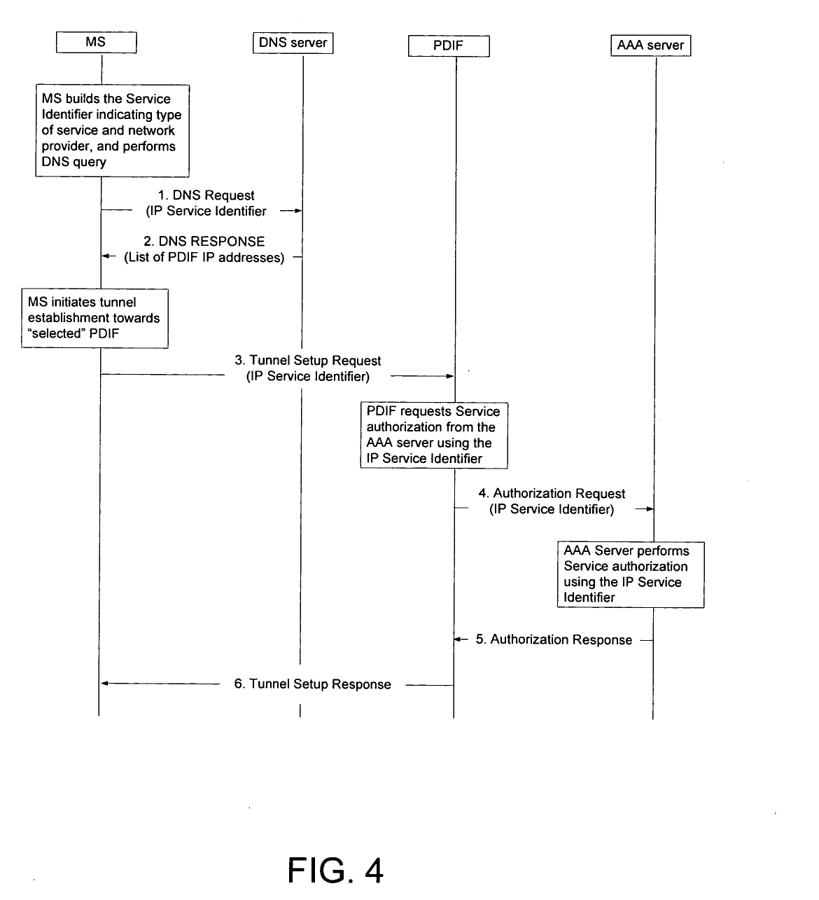

FIG. 4 is a signal flow diagram illustrating the PDIF selection process according to exemplary embodiments of the present invention. As stated above, while the exemplary embodiment illustrated by FIG. 4 involves the selection of a PDIF for accessing at least one of a plurality of CDMA2000 Packet Data Services, application of the present invention is not limited to CDMA2000 Packet Data Services or to the selection of a PDIF. In contrast, exemplary embodiments of the present invention can be used more generally in the selection of an RTE for accessing at least one of a plurality of services. In Step 1, the MS builds an ISI indicating one or more of the types of service being requested, the network operator, and the location of the service provider, and performs a DNS query by transmitting a DNS Request including this ISI to a DNS server. As noted above, the DNS server will use the information in the ISI to retrieve (or generate) and compile a list of the addresses of applicable PDIFs. In Step 2, the DNS server will communicate this list to the MS.

After receiving the list of applicable PDIFs from the DNS server, the MS will select one (or more) and initiate tunnel establishment toward the selected PDIF by sending a tunnel setup request, including the ISI, to the PDIF, as shown in Step 3. Alternatively, the DNS server could provide the list of applicable PDIFs to the network operator, in addition to or instead of the MS, such that the network operator may select the desired PDIF and advise the MS to initiate the tunnel establishment procedure. In Step 4, the PDIF will request service authorization from the AAA server, such as the H-AAA server, using the ISI by sending an authorization request including the ISI to the AAA server. In Step 5, the AAA server will perform service authorization using the ISI and then transmit an authorization response to the PDIF. Finally, the PDIF will transmit this response to the MS in Step 6. Where the authorization is given, the MS will initiate IPSec tunnel establishment toward the PDIF. In one embodiment, the MS supports IKEv2 (Internet Key Exchange version 2) for the IPSec tunnel negotiation, in order to establish trusted relationships.

Embodiments of the present invention provide an improvement over the prior art by creating more flexibility for network operators to deploy services, such as through WLAN IW. For example, an operator may offer some services (e.g., IMS, Emergency Services) only via some of the available PDIFs. Under embodiments of the present invention, when the MS requests that service, it is able to access the appropriate PDIF directly. The operator could also decide to provide certain services, like Emergency services, through the PDIF of a roaming partner. The mobile station subscriber may also benefit from the present invention by being able to select a network provider (i.e., a PDIF) based on, for example, the charging or perceived quality of the service.

As described above and as will be appreciated by one skilled in the art, embodiments of the present invention may be configured as a system, method, mobile terminal device or other apparatus, or computer program product. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. For example, although certain embodiments of the present invention were described in conjunction with CDMA2000 networks, the system and method of the present invention may also have application to other types of networks. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of establishing a tunnel to a remote tunnel endpoint, said method comprising:
building an identifier identifying one or more characteristics of one or more services being accessed;
transmitting a request for one or more addresses associated with one or more remote tunnel endpoints through which the services can be accessed, wherein the request includes the identifier;
receiving, in response to the request, one or more addresses associated with one or more remote tunnel endpoints that are capable of supporting the tunnel for accessing the services described in the identifier;
selecting one or more of the addresses received; and
initiating tunnel establishment toward one or more remote tunnel endpoints associated with the one or more addresses selected.

2. The method of claim 1, wherein the identifier is a Fully Qualified Domain Name.

3. The method of claim 1, wherein the one or more characteristics of the services being accessed comprise some combination of an identification of the services being accessed, an indication of a network operator associated with the services, and an indication of a service provider for a mobile station accessing the services.

4. The method of claim 1, wherein selecting one or more of the addresses received comprises automatically selecting one or more of the addresses received.

5. The method of claim 1 further comprising, prior to selecting one or more of the addresses received:
receiving an instruction of which of said one or more addresses to select.

6. The method of claim 5, wherein said instruction is received from a user of a mobile station accessing the services.

7. The method of claim 5, wherein said instruction is received from a network operator associated with the services being accessed.

8. The method of claim 1, wherein initiating tunnel establishment toward one or more remote tunnel endpoints associated with the one or more addresses selected comprises transmitting a signal to the one or more remote tunnel endpoints, wherein the signal includes the identifier.

9. The method of claim 1, wherein the one or more remote tunnel endpoints comprise one or more Packet Data Interworking Functions (PDIFs), and wherein the services comprise one or more CDMA2000 Packet Data Services.

10. The method of claim 1, wherein the request is a Domain Name System (DNS) request, and wherein the request is transmitted to a DNS Server.

11. A method of selecting a Packet Data Interworking Function (PDIF) for the purpose of establishing a tunnel to enable a mobile station to access at least one of a plurality of packet data services, said method comprising:
building an IP Service Identifier (ISI) identifying the packet data service being accessed and a network operator associated with the packet data service;
transmitting a Domain Name System (DNS) request, wherein the DNS request includes the ISI;
receiving, in response to the DNS request, one or more IP addresses associated with one or more PDIFs that are capable of supporting the tunnel for accessing the packet data service described in the ISI;
selecting one or more of the IP addresses received; and
initiating tunnel establishment toward one or more PDIFs associated with the one or more IP addresses selected.

12. The method of claim 11, wherein transmitting said DNS request comprises transmitting the DNS request to a DNS server, said DNS server capable of generating said one or more IP addresses associated with said one or more PDIFs based at least in part on said ISI.

13. The method of claim 11, wherein selecting one or more of the IP addresses received comprises automatically selecting one or more of the IP addresses received.

14. The method of claim 11 further comprising, prior to selecting one or more of the IP addresses received:
receiving an instruction of which of said one or more IP addresses to select.

15. The method of claim 11, wherein the ISI is a Fully Qualified Domain Name.

16. An apparatus capable of establishing a tunnel to a remote tunnel endpoint, said apparatus comprising:
a processor; and
a memory component in communication with the processor that stores an application executable by the processor, wherein the application is capable, upon execution, of building an identifier identifying one or more characteristics of a service being accessed, said application further capable, upon execution, of transmitting a request to a network server, said request including the identifier, said application further capable, upon execution, of receiving, in response to the request, one or more addresses associated with one or more remote tunnel endpoints, and said application further capable, upon execution, of selecting one or more of said addresses received and initiating tunnel establishment toward one or more remote tunnel endpoints associated with the one or more addresses selected.

17. The apparatus of claim 16, wherein the identifier is a Fully Qualified Domain Name.

18. The apparatus of claim 16, wherein the one or more characteristics of the service identified in the identifier comprise some combination of an identification of the service being accessed, an indication of a network operator associated with the service, and an indication of a service provider for the apparatus.

19. The apparatus of claim 16, wherein selecting one or more of said addresses received comprises automatically selecting one or more of said addresses received.

20. The apparatus of claim 16, wherein the application is further capable, upon execution, of, prior to selecting one or more of said addresses received, receiving an instruction of which of said addresses to select.

21. The apparatus of claim 16, wherein initiating tunnel establishment toward one or more remote tunnel endpoints associated with the one or more addresses selected comprises transmitting a signal to the one or more remote tunnel endpoints, wherein the signal includes the identifier.

22. The apparatus of claim 16, wherein the one or more remote tunnel endpoints comprise one or more Packet Data Interworking Functions (PDIFs), and wherein the service comprises a CDMA2000 Packet Data Service.

23. A mobile station capable of requesting and selecting a remote tunnel endpoint for the purpose of establishing a tunnel to be used when accessing at least one of a plurality of services, said mobile station comprising:
means for building an identifier identifying one or more characteristics of the service being accessed by the mobile station;
means for transmitting a request for one or more addresses associated with one or more remote tunnel endpoints through which the mobile station can access the service, said request including the identifier;
means for receiving, in response to the request, one or more addresses associated with one or more remote tunnel endpoints that are capable of supporting the tunnel for accessing the service described in the identifier;
means for selecting one or more of the addresses received; and
means for initiating tunnel establishment toward one or more remote tunnel endpoints associated with the one or more addresses selected.

24. The mobile station of claim 23, wherein the identifier is a Fully Qualified Domain Name.

25. The mobile station of claim 23, wherein the one or more characteristics of the service identified in the identifier comprise some combination of an identification of the service being accessed, an indication of a network operator associated with the service, and an indication of a service provider for the mobile station

26. The mobile station of claim 23, wherein selecting one or more of the addresses received comprises automatically selecting one or more of the addresses received.

27. The mobile station of claim 23, further comprising means for receiving an instruction of which of said one or more addresses to select.

28. A server capable of providing one or more addresses associated with one or more remote tunnel endpoints that can be used by a mobile station to establish a tunnel for accessing at least one of a plurality of services, said server comprising:
a processing device capable of receiving a request from the mobile station for one or more addresses associated with one or more remote tunnel endpoints through which the mobile station can access one of said plurality of services, wherein the request includes one or more characteristics of the service the mobile station desires to access, said processing device also capable of providing to the mobile station one or more addresses associated with one or more remote tunnel endpoints that are capable of supporting access to the service, based at least in part on the characteristics of the service included in the request.

29. The server of claim 28, wherein the processing device is further capable of generating said one or more addresses associated with said one or more remote tunnel endpoints.

30. The server of claim 28, wherein the processing device is further capable of retrieving said one or more addresses associated with said one or more remote tunnel endpoints.

31. The server of claim 28, wherein the one or more characteristics of the service included in the request comprise some combination of an identification of the service being accessed, an indication of a network operator associated with the service, and an indication of a service provider for the mobile station.

32. The server of claim 28, wherein the server comprises a Domain Name System (DNS) server, and wherein the request comprises a DNS request.

33. A server capable of providing one or more addresses associated with one or more remote tunnel endpoints that can be used by a mobile station to establish a tunnel for accessing at least one of a plurality of services, said server comprising:
means for receiving a request from the mobile station for one or more addresses associated with one or more remote tunnel endpoints through which the mobile station can access one of said plurality of services, wherein the request includes one or more characteristics of the service the mobile station desires to access; and
means for providing to the mobile station one or more addresses associated with one or more remote tunnel endpoints that are capable of supporting access to the service, based at least in part on the characteristics of the service included in the request.

34. The server of claim 33 further comprising:
means for generating said one or more addresses associated with one or more remote tunnel endpoints.

35. The server of claim 33 further comprising:
means for retrieving said one or more addresses associated with one or more remote tunnel endpoints.

36. The server of claim 33, wherein the one or more characteristics of the service included in the request comprise some combination of an identification of the service being accessed, an indication of a network operator associated with the service, and an indication of a service provider for the mobile station.

37. The server of claim 33, wherein the server comprises a Domain Name System (DNS) server, and wherein the request comprises a DNS request.

38. The server of claim 33, wherein the plurality of services comprises a plurality of CDMA2000 Packet Data Services, and wherein the one or more remote tunnel endpoints comprise one or more Packet Data Interworking Functions (PDIFs).

39. A system for establishing a tunnel to a remote terminal endpoint, said system comprising:
a mobile station capable of generating a request for one or more addresses associated with one or more remote tunnel endpoints through which the mobile station can access one of a plurality of services, said request including an identifier identifying one or more characteristics of the service the mobile station desires to access; and
a server in communication with the mobile station for the purpose of receiving the request from the mobile station, wherein the server, in response to receiving the request, is capable of providing to the mobile station one of more addresses associated with one or more remote tunnel endpoints that can be used by the mobile station to access the service, based at least in part on the one or more characteristics of the service included in the identifier,
wherein the mobile station selects one or more of the addresses provided by the server and initiates tunnel establishment toward one or more remote tunnel endpoints associated with the one or more addresses selected.

40. The system of claim 39, wherein the identifier is a Fully Qualified Domain Name.

41. The system of claim 39, wherein the server is further capable of generating the one or more addresses associated with the one or more remote tunnel endpoints.

42. The system of claim 39, wherein the server is further capable of retrieving the one or more addresses associated with the one or more remote tunnel endpoints.

43. The system of claim 39, wherein the one or more characteristics of the service being accessed by the mobile station comprise some combination of an identification of the service being accessed, an indication of a network operator associated with the service, and an indication of a service provider for the mobile station.

44. The system of claim 39, wherein the one or more remote tunnel endpoints comprise one or more Packet Data Interworking Functions (PDIFs), wherein said server comprises a Domain Name System (DNS) server, and wherein the plurality of services comprises a plurality of CDMA2000 Packet Data Services.

45. A computer program product for selecting a remote tunnel endpoint for the purpose of establishing a tunnel to enable a mobile station to access at least one of a plurality of services, wherein the computer program product comprises at least one computer-readable storage medium having computer-readable program code portions stored therein, the computer-readable program code portions comprising:
a first executable portion for building an identifier identifying one or more characteristics of the service being accessed by the mobile station;
a second executable portion for transmitting a request for one or more addresses associated with one or more remote tunnel endpoints through which the mobile station can access the service, wherein the request includes the identifier;
a third executable portion for receiving, in response to the request, one or more addresses associated with one or more remote tunnel endpoints that are capable of supporting the tunnel for accessing the service described in the identifier;
a fourth executable portion for selecting one or more of the addresses received; and
a fifth executable portion for initiating tunnel establishment toward one or more remote tunnel endpoints associated with the one or more addresses selected.

46. The computer program product of claim 45, wherein the identifier is a Fully Qualified Domain Name.

47. The computer program product of claim 45, wherein the one or more characteristics of the service being accessed by the mobile station comprise some combination of an identification of the service being accessed, an indication of a network operator associated with the service, and an indication of a service provider for the mobile station.

48. The computer program product of claim 45, wherein selecting one or more of the addresses received comprises automatically selecting one or more of the addresses received.

49. The computer program product of claim 45 further comprising:
a sixth executable portion for, prior to selecting one or more of the addresses received, receiving an instruction of which of said one or more addresses to select.

50. The computer program product of claim 45, wherein the one or more remote tunnel endpoint comprise one or more Packet Data Interworking Functions (PDIFs), and wherein the plurality of services comprises a plurality of CDMA2000 Packet Data Services.

51. The computer program product of claim 47, wherein the request is a Domain Name System (DNS) request, and wherein said DNS request is transmitted to a DNS Server.
